(19) United States
(12) Patent Application Publication
(10) Pub. No.: US 2024/0273459 A1
(43) Pub. Date: Aug. 15, 2024

(54) DISPLAY METHOD, DISPLAY CONTROL APPARATUS, AND NON-TRANSITORY COMPUTER-READABLE STORAGE MEDIUM STORING A COMPUTER PROGRAM

(71) Applicant: SUMITOMO ELECTRIC INDUSTRIES, LTD., Osaka-shi, Osaka (JP)

(72) Inventors: Yu URATA, Osaka-shi (JP); Shigeki NISHIMURA, Osaka-shi (JP); Norio KOREKAWA, Osaka-shi (JP); Takeshi HACHIKAWA, Osaka-shi (JP); Tomoyuki KITADA, Osaka-shi (JP)

(73) Assignee: SUMITOMO ELECTRIC INDUSTRIES, LTD., Osaka-shi, Osaka (JP)

(21) Appl. No.: 18/563,572

(22) PCT Filed: Feb. 4, 2022
(86) PCT No.: PCT/JP2022/004363

§ 371 Date: Nov. 22, 2023

(30) Foreign Application Priority Data
Jun. 10, 2021 (JP) 2021-097082

(51) Int. Cl. G06Q 10/0835; G06Q 10/0833; G06Q 50/40; G09B 29/10

(52) U.S. Cl. CPC G06Q 10/08355; G06Q 10/0833; G06Q 50/40; G09B 29/10

(57) ABSTRACT

A display method is for displaying a delivery status of a related package on a terminal device used by a user, the related package being a package related to the user. The display method includes acquiring route information of a delivery route of target packages to be delivered by a vehicle, acquiring position information of the vehicle, and displaying, on the terminal device, a map with an abstracted route and an icon superimposed thereon, based on the route information and the position information, the abstracted route being a route from a delivery origin of the related package to a delivery destination of the related package and being a route excluding a delivery destination of a non-related package that is a package not related to the user among the target packages, the icon indicating a position of the vehicle on the abstracted route

### TECHNICAL FIELD

The present disclosure relates to a display method, a display control apparatus, and a computer program. This application claims priority to Japanese Patent Application No. 2021-097082 filed on Jun. 10, 2021, the entire contents of which are incorporated herein by reference.

### BACKGROUND ART

From the viewpoint of efficiency of package delivery, collective delivery is known in which packages collected from a plurality of shippers are mixedly loaded in the same delivery vehicle and delivered to a plurality of recipients.

In collective delivery, since the mixedly loaded delivery vehicle delivers the packages via various points, a delivery client (shipper or recipient) desires to confirm the delivery status of the package.

On the other hand, in such collective delivery, if a delivery route of a package from a certain shipper to a certain recipient is known to another shipper or another recipient, there is a possibility that a trade secret of a business partner or the like is known to a competitor or the like.

Therefore, there is a need for a mechanism that allows a shipper or a recipient to confirm the delivery status of the package without the delivery route being known to another shipper or another recipient.

PTL 1 discloses an information processing system in which, for example, in order to prevent a predetermined point such as a user's home or office from being known, the vicinity of the predetermined point is displayed with a circle, or a route to the predetermined point is changed to a route to an intersection of the vicinity of the predetermined point and displayed.

### CITATION LIST

### Patent Literature

PTL 1: Japanese Unexamined Patent Application Publication No. 2014-025714

### SUMMARY OF INVENTION

A display method according to an embodiment of the present disclosure is a display method for displaying a delivery status of a related package on a terminal device used by a user, the related package being a package related to the user. The display method includes acquiring route information of a delivery route of target packages to be delivered by a vehicle; acquiring position information of the vehicle; and displaying, on the terminal device, a map with an abstracted route and an icon superimposed thereon, based on the route information and the position information, the abstracted route being a route from a delivery origin of the related package to a delivery destination of the related package and being a route excluding a delivery destination of a non-related package that is a package not related to the user among the target packages, the icon indicating a position of the vehicle on the abstracted route, the position of the vehicle on the abstracted route corresponding to a position of the vehicle on a delivery route of the related package.

A display control apparatus according to another aspect of the present disclosure is a display control apparatus for causing a terminal device used by a user to display a delivery status of a related package, the related package being a package related to the user. The display control apparatus includes a route information acquisition unit configured to acquire route information of a delivery route of target packages to be delivered by a vehicle; a position information acquisition unit configured to acquire position information of the vehicle; and a display control unit configured to cause the terminal device to display a map with an abstracted route and an icon superimposed thereon, based on the route information and the position information, the abstracted route being a route from a delivery origin of the related package to a delivery destination of the related package and being a route excluding a delivery destination of a non-related package not related to the user among the target packages, the icon indicating a position of the vehicle on the abstracted route, the position of the vehicle on the abstracted route corresponding to a position of the vehicle on a delivery route of the related package.

A computer program according to another aspect of the present disclosure is a computer program for causing a computer to function as a display control apparatus for causing a terminal device used by a user to display a delivery status of a related package, the related package being a package related to the user. The computer program causes the computer to function as: a route information acquisition unit configured to acquire route information of a delivery route of target packages to be delivered by a vehicle; a position information acquisition unit configured to acquire position information of the vehicle; and a display control unit configured to cause the terminal device to display a map with an abstracted route and an icon superimposed thereon, based on the route information and the position information, the abstracted route being a route from a delivery origin of the related package to a delivery destination of the related package and being a route excluding a delivery destination of a non-related package that is a package not related to the user among the target packages, the icon indicating a position of the vehicle on the abstracted route, the position of the vehicle on the abstracted route corresponding to a position of the vehicle on a delivery route of the related package.

The present disclosure can also be achieved as a computer program for causing a computer to execute the characteristic steps included in the display method. It is needless to say that such a computer program can be distributed via a computer-readable non-transitory recording medium such as a compact disc-read only memory (CD-ROM) or a communication network such as the Internet.

### BRIEF DESCRIPTION OF THE DRAWINGS

FIG. 1 is a diagram for explaining an example of a mechanism of collective delivery.

FIG. 2 is a diagram showing an overall configuration of a collective delivery system, a collective delivery management system, or an information system used in collective delivery system according to embodiment 1 of the present disclosure.

FIG. 3 is a diagram showing an example of a configuration of a display control apparatus according to embodiment 1 of the present disclosure.

FIG. 4 is a diagram showing an example of route information.

FIG. 5 is a flowchart showing an example of a processing procedure of the display control apparatus.

FIG. 6 is a diagram in which a delivery route of a delivery vehicle indicated by route information is displayed on a map indicated by map information.

FIG. 7 is a diagram showing an example of display data displayed on the display screens of the terminal devices used by a shipper Y and a recipient B.

FIG. 8 is a diagram showing an example of display data generated in the display data display processing (step S9 in FIG. 5).

FIG. 9 is a diagram showing an example of display data generated in the display data display processing (step S9 in FIG. 5).

FIG. 10 is a diagram showing an example of display data generated in the display data display processing (step S9 in FIG. 5).

FIG. 11 is a diagram showing an example of display data displayed on the display screens of the terminal devices used by shipper Y and recipient B.

FIG. 12 is a diagram showing an example of display data displayed on the display screens of the terminal devices used by shipper Y and recipient B.

### DETAILED DESCRIPTION

### Problems to be Solved by Present Disclosure

When the information processing system disclosed in PTL 1 is used for collective delivery, the following problems occur.

That is, when the predetermined point is set as a delivery destination of a competitor or the like, a circle is suddenly displayed at the delivery destination, or a route making a U-turn at an intersection of the vicinity of the delivery destination is displayed. In this way, unnatural route is displayed.

In addition, when the size of the circle is small or when the intersection point is close to the delivery destination, there is a possibility that the delivery destination is analogized to another person.

The present disclosure has been made in view of such circumstances and an object of the present disclosure is to provide a display method, a display control apparatus, and a computer program capable of naturally displaying a delivery status of a package without notifying another shipper or another recipient of the delivery route.

### Advantageous Effects of Present Disclosure

The present disclosure allows for naturally displaying the delivery status of the package without notifying another shipper or another recipient of the delivery route.

### Description of Embodiments of Present Disclosure

First, a summary of embodiments of the present disclosure is listed and described.
(1) A display method according to an embodiment of the present disclosure is a display method for displaying a delivery status of a related package on a terminal device used by a user, the related package being a package related to the user. The display method includes acquiring route information of a delivery route of target packages to be delivered by a vehicle; acquiring position information of the vehicle; and displaying, on the terminal device, a map with an abstracted route and an icon superimposed thereon, based on the route information and the position information, the abstracted route being a route from a delivery origin of the related package to a delivery destination of the related package and being a route excluding a delivery destination of a non-related package that is a package not related to the user among the target packages, the icon indicating a position of the vehicle on the abstracted route, the position of the vehicle on the abstracted route corresponding to a position of the vehicle on a delivery route of the related package.

According to this configuration, since the delivery destination of the non-related package is not included in the abstracted route, the delivery destination of the non-related package is not displayed on the map. Therefore, the delivery route of the non-related package is not known to the user. Also, an icon is displayed at a position on the abstracted route corresponding to the position of the vehicle in the delivery route. Therefore, the user can grasp the rough position of the vehicle and can confirm the delivery status. For this reason, it is possible to naturally display the delivery status of the related package to the user without the delivery route of the non-related package being known to the user who is another shipper or another recipient.
(2) The abstracted route may be a straight line or a curved line connecting the delivery origin of the related package and the delivery destination of the related package.

According to this configuration, the icon corresponding to the position of the vehicle can be displayed on the straight line or the curved line connecting the delivery origin and the delivery destination. Therefore, the user can intuitively grasp the rough position of the vehicle, the remaining distance to the delivery destination, and the like.
(3) The abstracted route may be an area based on an arrival distance or an arrival time from the delivery origin of the related package or the delivery destination of the related package.

According to this configuration, the icon corresponding to the position of the vehicle can be displayed on the area based on the arrival distance or the arrival time from the delivery origin or the delivery destination. Therefore, the user can intuitively grasp the arrival distance or arrival time of the vehicle from the delivery origin or delivery destination.
(4) The displaying may further superimpose an icon on the map in vicinity of the delivery destination of the related package, the icon indicating the position of the vehicle on the delivery route of the related package.

According to this configuration, when the related package approaches the delivery destination, the user can know the accurate position of the vehicle.
(5) The display method may further include acquiring congested section information of a congested section on the delivery route. The displaying may further display the congested section, based on the congested section information, in such a manner as to superimpose the congested section on the abstracted route.

According to this configuration, since the congested section is displayed on the abstracted route, the user can easily know whether the vehicle exists in the congested section by viewing the icon.
(6) The displaying may further display a corresponding line and an icon on the terminal device, the corresponding line corresponding to the delivery route of the related package, the icon indicating a position of the vehicle on the corresponding line, the position of the vehicle on the corresponding line corresponding to the position of the vehicle on the delivery route.

According to this configuration, the user can intuitively grasp the degree of progress of delivery by the vehicle by viewing the corresponding line and the icon on the corresponding line.
(7) The displaying may further display remaining information on the terminal device, the remaining information being related to a remaining distance or a remaining time to the delivery destination of the related package.

According to this configuration, the user can confirm the remaining information related to the remaining distance or remaining time to the delivery destination.
(8) The displaying may superimpose, on the map, the delivery route of the related package and an icon indicating the position of the vehicle on the delivery route when the delivery destination of the non-related package is not on the delivery route.

According to this configuration, when there is no transit point of the competitor or the like on the delivery route of the related package, the user can confirm the accurate delivery route from the delivery origin to the delivery destination and the position of the vehicle.
(9) The user may be a shipper of a package, and the related package may be a package delivered from the shipper.

According to this configuration, delivery routes of packages other than the package delivered from the shipper cannot be shown to the shipper of the package.
(10) The user may be a recipient of a package, and the related package may be a package to be delivered to the recipient.

According to this configuration, delivery routes of packages other than the package delivered to the recipient cannot be shown to the recipient of the package.
(11) The user may be an administrator for the vehicle, and the related package may be a package to be delivered by the vehicle.

According to this configuration, delivery routes of packages other than the package delivered by the vehicle cannot be shown to the administrator of the vehicle. That is, it is possible to prevent the administrator of the vehicle from showing the delivery route of the package delivered by the vehicle managed by another administrator.
(12) The display method may further include determining the abstracted route when the non-related package is on the delivery route and the position of the vehicle is not in vicinity of the delivery destination of the related package.

According to this configuration, when there is a possibility that the delivery route of the non-related package is known to the user, an abstracted route that does not include the delivery destination of the non-related package is required. For this reason, it is possible to naturally display the delivery status of the related package to the user without the delivery route of the non-related package being known to the user who is another shipper or another recipient.
(13) A display control apparatus according to another embodiment of the present disclosure is a display control apparatus for causing a terminal device used by a user to display a delivery status of a related package, the related package being a package related to the user. The display control apparatus includes a route information acquisition unit configured to acquire route information of a delivery route of target packages to be delivered by a vehicle; a position information acquisition unit configured to acquire position information of the vehicle; and a display control unit configured to cause the terminal device to display a map with an abstracted route and an icon superimposed thereon, based on the route information and the position information, the abstracted route being a route from a delivery origin of the related package to a delivery destination of the related package and being a route excluding a delivery destination of a non-related package not related to the user among the target packages, the icon indicating a position of the vehicle on the abstracted route, the position of the vehicle on the abstracted route corresponding to a position of the vehicle on a delivery route of the related package.

This configuration includes processing units corresponding to the characteristic steps in the display method described above. Therefore, according to this configuration, the same operation and effect as those of the above-described display method can be achieved.
(14) A computer program according to another embodiment of the present disclosure is a computer program for causing a computer to function as a display control apparatus for causing a terminal device used by a user to display a delivery status of a related package, the related package being a package related to the user. The computer program causes the computer to function as: a route information acquisition unit configured to acquire route information of a delivery route of target packages to be delivered by a vehicle; a position information acquisition unit configured to acquire position information of the vehicle; and a display control unit configured to cause the terminal device to display a map with an abstracted route and an icon superimposed thereon, based on the route information and the position information, the abstracted route being a route from a delivery origin of the related package to a delivery destination of the related package and being a route excluding a delivery destination of a non-related package that is a package not related to the user among the target packages, the icon indicating a position of the vehicle on the abstracted route, the position of the vehicle on the abstracted route corresponding to a position of the vehicle on a delivery route of the related package.

This configuration can cause the computer to function as the above-described display control apparatus. Therefore, the same operation and effect as those of the above-described display control apparatus can be achieved.

### Details of Embodiments of Present Disclosure

Embodiments of the present disclosure are now described with reference to the drawings. It should be noted that each of the embodiments described below represents a specific example of the present disclosure. Numerical values, shapes, materials, constituent elements, arrangement positions and connection forms of constituent elements, steps, order of steps, and the like shown in the following embodiments are examples and do not limit the present disclosure. In addition, among the constituent elements in the following embodiments, constituent elements not recited in the independent claims are constituent elements that can be arbitrarily added. In addition, each drawing is a schematic diagram and is not necessarily strictly illustrated.

The same components are denoted by the same reference numerals. Since their functions and names are the same, their descriptions are omitted as appropriate.

### Embodiment 1

Embodiment 1 of the present disclosure describes a delivery system for a package using collective delivery.

### [Collective Delivery]

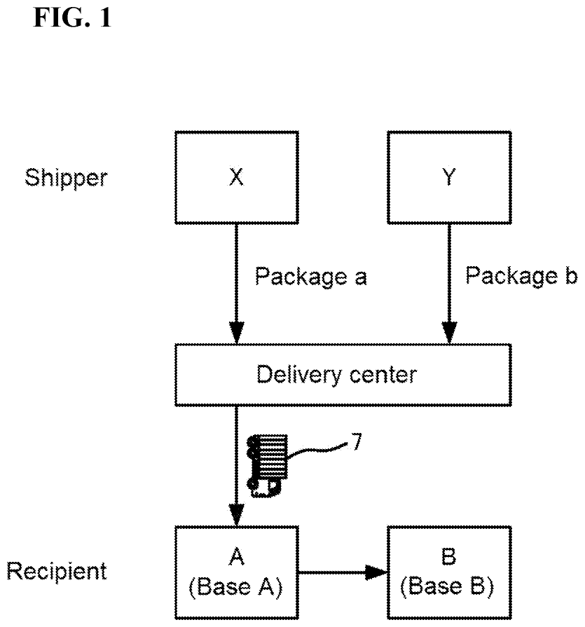

FIG. 1 is a diagram for explaining an example of a mechanism of collective delivery. Collective delivery is a mechanism in which a plurality of packages requested to be delivered by a plurality of shippers are mixedly loaded in the same vehicle and delivered to a delivery destination of a recipient of each package.

Referring to FIG. 1, for example, a shipper X requests a delivery of a package a to a recipient A located at a base A. A shipper Y requests a delivery of a package b to a recipient B located in a base B.

Packages a and b are collected from shippers X and Y to a delivery center, respectively. The collection may be performed by a vehicle managed by the delivery center or may be performed by vehicles managed by shippers X and Y.

A delivery vehicle 7 mixedly loads packages a and b of delivery targets at the delivery center, moves from the delivery center to base A, and package a is delivered to recipient A at base A. Thereafter, delivery vehicle 7 moves from base A to base B, and package b is delivered to recipient B at base B. In embodiment 1, there are two shippers and two recipients respectively, but there may be three or more shippers and three or more recipients.

### [Overall Configuration of Collective Delivery System]

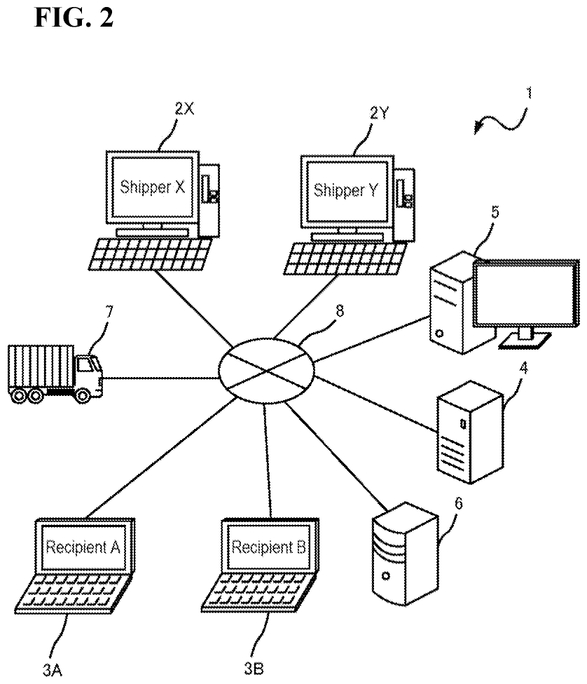

FIG. 2 is a diagram showing an overall configuration of a collective delivery system, a collective delivery management system, or an information system used in collective delivery system according to Embodiment 1 of the present disclosure. Referring to FIG. 2, a collective delivery system 1 is a system for managing collective delivery of packages, and includes shipper terminals 2X and 2Y, recipient terminals 3A and 3B, a display control apparatus 4, an administrator terminal 5, a traffic information providing device 6, and a delivery vehicle 7. Collective delivery system 1 shown in FIG. 2 may be a collective delivery management system or an information system used in collective delivery system.

Shipper terminals 2X and 2Y are terminal devices used by shippers X and Y shown in FIG. 1, respectively. Recipient terminals 3A and 3B are terminal devices used by recipients A and B shown in FIG. 1, respectively. Administrator terminal 5 is a terminal device used by the administrator of delivery vehicle 7 of the package, the administrator of the package delivered by delivery vehicle 7, or the administrator of the collective delivery system.

Display control apparatus 4 performs control for displaying the delivery status of the package on the display screens of shipper terminals 2X and 2Y, the display screens of recipient terminals 3A and 3B, and the display screen of administrator terminal 5. Traffic information providing device 6 provides the congested section information indicating the congested section occurring on the road.

Delivery vehicle 7 is a vehicle such as a truck or a van in which packages for a plurality of recipients are mixedly loaded and delivered to each recipient. For example, delivery vehicle 7 mixedly loads packages a and b and delivers to recipients A and B. Delivery vehicle 7 includes a position specifying unit for specifying the position of delivery vehicle 7. The position specifying unit specifies the position of delivery vehicle 7 using satellite navigation. For example, the position specifying unit specifies the position of delivery vehicle 7 based on radio waves received from a plurality of GPS (Global Positioning System) satellites. The position of delivery vehicle 7 can be specified by, for example, latitude and longitude. The satellite navigation uses a global navigation satellite system (GNSS) such as the GPS, but is not limited to the GPS. The position specifying unit may be, for example, a smart phone or a tablet terminal.

Shipper terminals 2X and 2Y, recipient terminals 3A and 3B, display control apparatus 4, administrator terminal 5, traffic information providing device 6, and delivery vehicle 7 are connected to a network 8 such as the Internet in a wired or wireless manner, and can transmit and receive data to and from each other.

### [Configuration of Display Control Apparatus 4]

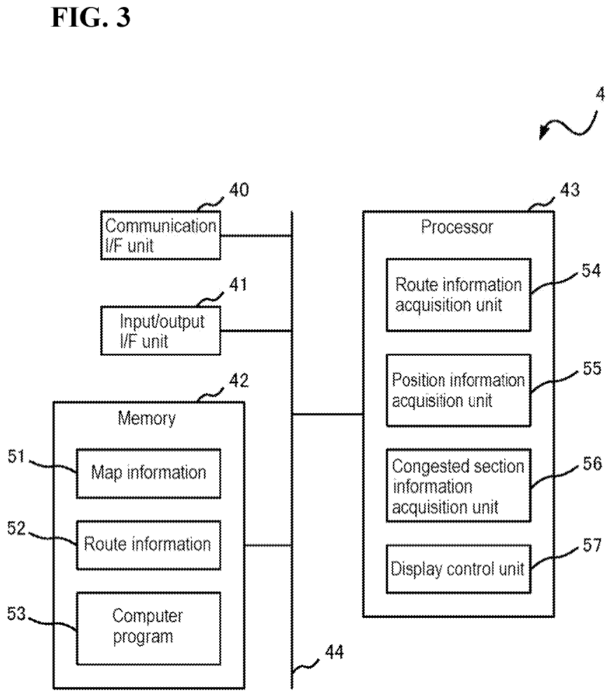

FIG. 3 is a diagram showing an example of a configuration of display control apparatus 4 according to Embodiment 1 of the present disclosure. Display control apparatus 4 is configured by a computer and includes a communication I/F (interface) unit 40, an input/output I/F unit 41, a memory 42, and a processor 43 which are connected to each other via a bus 44. Communication I/F unit 40 includes a communication module for performing wired or wireless communication with an external apparatus.

Input/output I/F unit 41 includes an interface for connecting an input device such as a keyboard or a mouse and an output device such as a display apparatus to display control apparatus 4.

Memory 42 is constituted by a volatile memory element such as a Static RAM (SRAM) or a Dynamic RAM (DRAM), a nonvolatile memory element such as a flash memory or an Electrically Erasable Programmable Read Only Memory (EEPROM), a magnetic storage apparatus such as a hard disk, or the like. Memory 42 stores a computer program 53 to be executed by processor 43. Memory 42 stores a map information 51, a route information 52, and the like which are used when computer program 53 is executed. Further, memory 42 stores data generated when computer program 53 is executed.

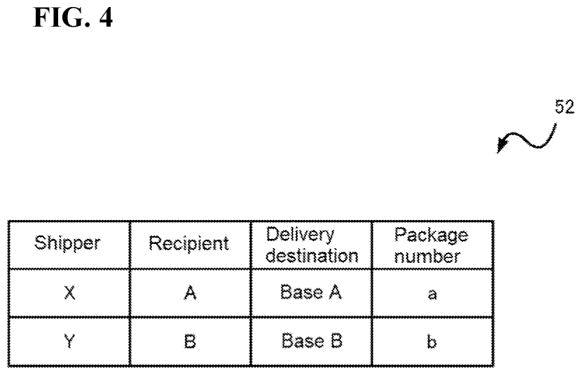

FIG. 4 is a diagram showing an example of route information 52. Route information 52 includes information of shipper, recipient, delivery destination, and package number. Delivery vehicle 7 delivers the mixedly loaded packages according to route information 52. Note that delivery vehicle 7 performs processing sequentially from the top row of route information 52. That is, route information 52 indicates that after the package (package a) of a package number a from shipper X to recipient A is delivered to base A, the package (package b) of a package number b from shipper Y to recipient B is delivered to base B. The information of the delivery destination includes the position information of the delivery destination.

Referring again to FIG. 3, processor 43 is constituted by a Central Processing Unit (CPU) or the like, and includes a route information acquisition unit 54, a position information acquisition unit 55, a congested section information acquisition unit 56, and a display control unit 57 as functional processing units achieved by executing computer program 53 stored in memory 42.

Route information acquisition unit 54 acquires route information 52 by reading route information 52 of the delivery route from memory 42. When route information 52 is stored in the external device, route information acquisition unit 54 may receive route information 52 from the external device via communication I/F unit 40.

Position information acquisition unit 55 acquires the position information of delivery vehicle 7 by receiving the position information of delivery vehicle 7 from delivery vehicle 7 via communication I/F unit 40. Note that position information acquisition unit 55 may receive the position information of delivery vehicle 7 not directly from delivery vehicle 7 but from the other apparatus. The other apparatus may be, for example, a smartphone, a tablet terminal, etc.

Congested section information acquisition unit 56 acquires the congested section information by receiving the congested section information from traffic information providing device 6 via communication I/F unit 40.

Display control unit 57 generates display data of the delivery status of the package to be displayed on the display screens of shipper terminals 2X and 2Y, recipient terminals 3A and 3B, and administrator terminal 5 based on map information 51 stored in memory 42, route information 52 acquired by route information acquisition unit 54, the position information of delivery vehicle 7 acquired by position information acquisition unit 55, and the congested section information acquired by congested section information acquisition unit 56. Display control unit 57 transmits the generated display data to each terminal via communication I/F unit 40 to display the display data on the display screen of each terminal.

### [Processing Procedure of Display Control Apparatus 4]

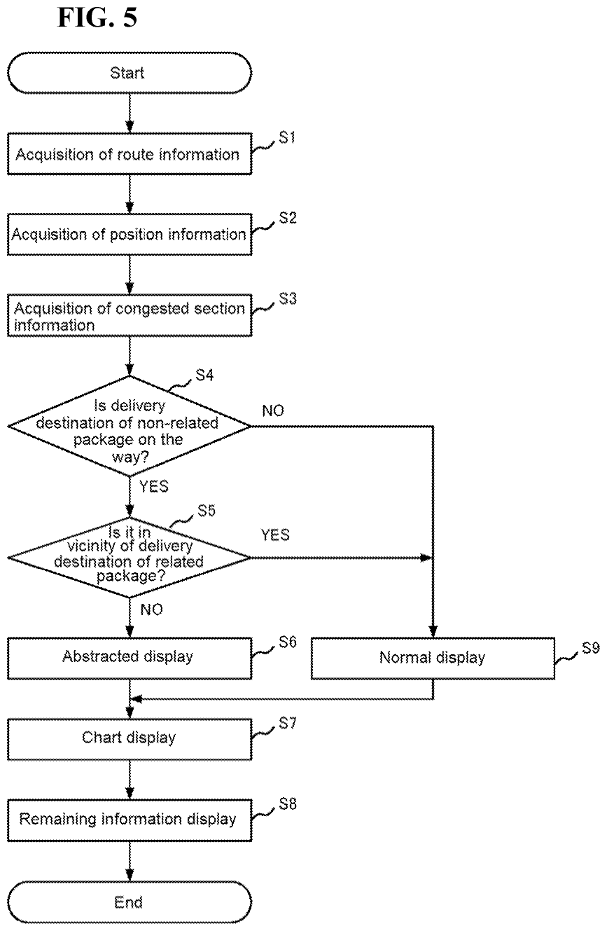

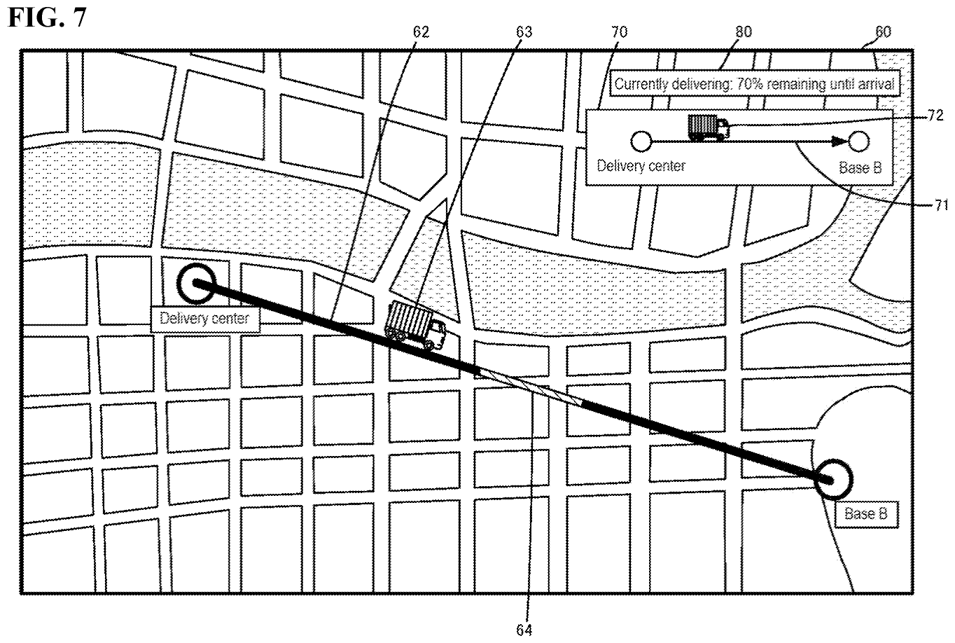

FIG. 5 is a flowchart showing an example of a processing procedure of display control apparatus 4. The processing shown in FIG. 5 is a processing for displaying the display data on the display screen of each of terminals (shipper terminals 2X, 2Y, recipient terminals 3A, 3B, and administrator terminal 5) used by the user (shipper, recipient, delivery vehicle 7, or package administrator), and is executed for each user. Accordingly, a different display screen (see FIGS. 7 to 12) is displayed for each terminal used by the user.

First, processing for shipper Y (shipper terminal 2Y) and recipient B (recipient terminal 3B) is described as an example. Referring to FIG. 5, route information acquisition unit 54 reads route information 52 from memory 42 (step S1).

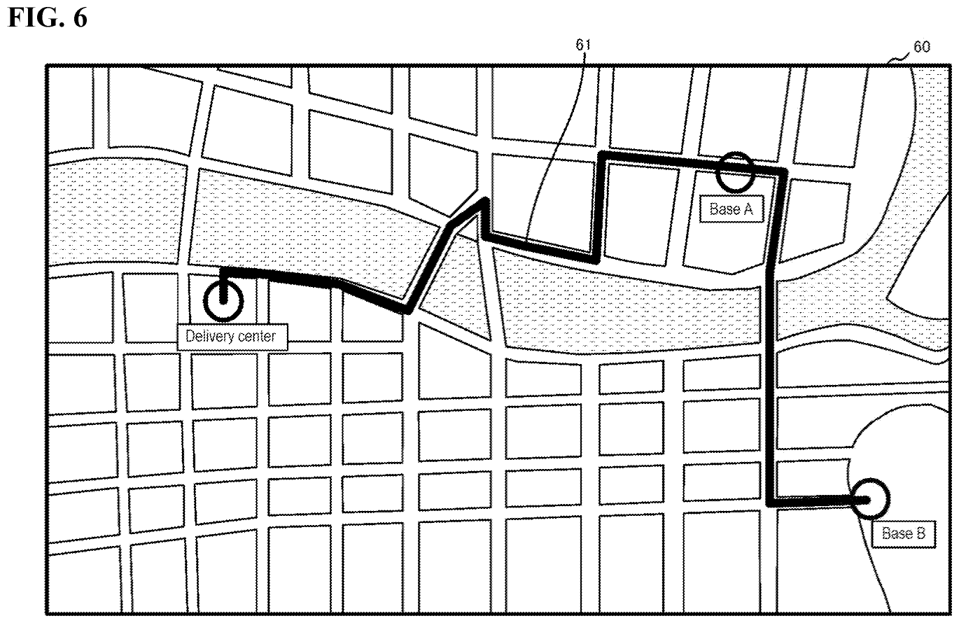

FIG. 6 is a diagram in which the delivery route of delivery vehicle 7 indicated by route information 52 is displayed on the map indicated by map information 51. Referring to FIG. 6, a delivery route 61 moving from a delivery center to base A and from base A to base B is shown on a map 60. As shown in FIG. 6, delivery route 61 may be displayed on administrator terminal 5. The processing procedure of FIG. 5 is described by taking FIG. 6 as an example.

Referring to FIG. 5, position information acquisition unit 55 receives the position information of delivery vehicle 7 from delivery vehicle 7 via communication I/F unit 40 (step S2).

Congested section information acquisition unit 56 receives the congested section information from traffic information providing device 6 via communication I/F unit 40 (step S3).

Display control unit 57 determines whether or not a delivery destination of a non-related package (described later) is on delivery route 61 of a related package (described later) (step S4).

Here, the related package and the non-related package are described. The related package indicates a package related to the user, such as a package shipped from the user when the user is a shipper and a package delivered to the user when the user is a recipient. For example, the related package for shipper X and recipient A is package a, and the related package for shipper Y and recipient B is package b.

Further, when the user is the administrator of delivery vehicle 7 or the package, the related package indicates the packages delivered by delivery vehicle 7. For example, the related packages for the administrator of delivery vehicle 7 are packages a and b.

A non-related package is a package that is not related to a user. In other words, the non-related package is a package excluding the related package from the delivery target package by delivery vehicle 7. For example, the non-related package for shipper X and recipient A is package b, and the non-related package for shipper Y and recipient B is package a. Further, there is no non-related package for the administrator of delivery vehicle 7 or the administrator of the package delivered by delivery vehicle 7 in delivery target packages a and b.

In the example of FIG. 6, for shipper Y and recipient B, since base A, which is the delivery destination of a non-related package a, is on delivery route 61 (delivery route 61 from delivery center to base B) of related package b (YES in step S4), display control unit 57 shifts the processing to step S5.

In step S5, display control unit 57 determines whether or not the position of delivery vehicle 7 is in the vicinity of the delivery destination of the related package (step S5). Display control unit 57 may set a position within a predetermined distance from the delivery destination as the vicinity of the delivery destination, or may set a position reachable within a predetermined time from the delivery destination as the vicinity of the delivery destination.

When delivery vehicle 7 is located at the vicinity of the delivery destination of the related package (YES in step S5), display control unit 57 proceeds to step S9.

When delivery vehicle 7 is not located at the vicinity of the delivery destination of the related package (NO in step S5), display control unit 57 proceeds to step S6.

In step S6, display control unit 57 generates display data by abstracting the delivery route of delivery vehicle 7, and transmits the display data to the terminals (here, shipper terminal 2Y and recipient terminal 3B) used by the user, thereby causing the terminals to display the display data (step S6). That is, when a non-related package is on the delivery route of delivery vehicle 7 and the position of delivery vehicle 7 is not in the vicinity of the delivery destination of the related package, display control unit 57 obtains an abstracted route (described later) and generates display data including the abstracted route. Display control unit 57 generates the display data as follows.

FIG. 7 is a diagram showing an example of display data displayed on the display screens of the terminal devices (shipper terminal 2Y and recipient terminal 3B) used by shipper Y and recipient B.

Based on the route information and the position information, display control unit 57 generates display data in which an abstracted route 62 to be described later and an icon 63 indicating the position of delivery vehicle 7 are superimposed on map 60 indicated by map information 51.

Abstracted route 62 is a route from the delivery origin (delivery center) to the delivery destination (base B) of related package b, and is obtained by abstracting a route excluding base A which is the delivery destination of non-related package a. Here, a route obtained by connecting the delivery origin and the delivery destination with a straight line is referred to as abstracted route 62. Abstracted route 62 is a route in which a detailed route from the delivery origin to the delivery destination is concealed, and indicates a route in which delivery vehicle 7 does not travel (for example, a route passing through a point other than a road).

Icon 63 is arranged at a position on abstracted route 62 corresponding to the position of delivery vehicle 7 in delivery route 61 of related package b. For example, in delivery route 61 shown in FIG. 6, when the ratio of the distance from the delivery center to the position of delivery vehicle 7 to the distance from the delivery center to base B is 30%, display control unit 57 arranges icon 63 at the position of 30% from the delivery center of abstracted route 62. Here, the position of the delivery center is a position of 0% from the delivery center, and the position of base B is a position of 100% from the delivery center.

Also, display control unit 57 displays a congested section 64 on abstracted route 62 based on congested section information acquisition unit 56. For example, in delivery route 61 shown in FIG. 6, when congestion occurs in the section where the ratio of the distance from the delivery center to the distance from the delivery center to base B is 40% to 60%, display control unit 57 arranges congested section 64 in the section of 40% to 60% from the delivery center of abstracted route 62. Congested section 64 is displayed in a mode distinguishable from other sections (for example, a color or hatching different from other sections).

With this display, the delivery status to base A can be hidden from shipper Y and recipient B.

After displaying the display data, display control unit 57 generates a chart 70 indicating the delivery route of the related package in simplified form, and transmits the data of the chart to the terminal used by the user to display chart 70 on the terminal (step S7).

Referring to FIG. 7, chart 70 includes a corresponding line 71 corresponding to delivery route 61 of the related package and an icon 72 on corresponding line 71. Corresponding line 71 indicates a route from the delivery origin to the delivery destination of the target package by a straight line. Icon 72 is arranged at a position on corresponding line 71 corresponding to the position of delivery vehicle 7 in delivery route 61 of related package b. For example, in delivery route 61 shown in FIG. 6, when the ratio of the distance from the delivery center to the position of delivery vehicle 7 to the distance from the delivery center to base B is 30%, display control unit 57 arranges icon 72 at a position of 30% from the delivery center of corresponding line 71. Here, the position of the delivery center is a position of 0% from the delivery center, and the position of base B is a position of 100% from the delivery center.

Note that chart 70 may be arranged on map 60 as shown in FIG. 7 or may be arranged outside map 60.

After displaying chart 70, display control unit 57 generates a remaining information 80 related to the remaining distance or remaining time to the delivery destination of the related package, and transmits remaining information 80 to the terminal of the user, thereby displaying remaining information 80 on the terminal (step S8).

Referring to FIG. 7, remaining information 80 indicates the ratio of the remaining distance to the delivery destination of related package b. For example, when the ratio of the distance (route) from the position of delivery vehicle 7 to base B to the distance (route) from the delivery center to base B is 70%, “Currently delivering: 70% remaining until arrival” is generated as remaining information 80. Remaining information 80 may include the remaining distance or the remaining time to base B which is the delivery destination of related package b. In addition, remaining information 80 may include the ratio of the driving schedule time (remaining time) from the position of delivery vehicle 7 to base B to the driving schedule time from the delivery center to base B.

Display control apparatus 4 updates the data displayed on each terminal by repeating the processing shown in FIG. 5 at predetermined time intervals.

For example, when delivery vehicle 7 is located at the vicinity of base B in the route display shown in FIG. 7 (YES in step S5), display control apparatus 4 generates display data in which an icon indicating the position of delivery vehicle 7 in the delivery route of delivery vehicle 7 is superimposed on a map, and transmits the display data to the terminal used by the user, thereby displaying the display data on the terminal (step S9).

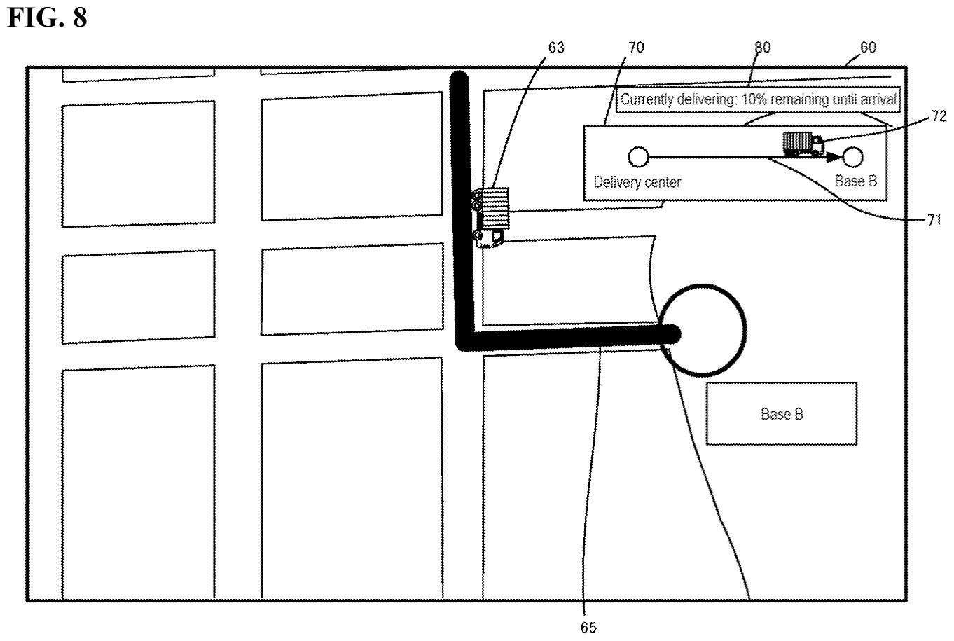

FIG. 8 is a diagram showing an example of display data generated in the display data display processing (step S9 in FIG. 5).

Based on the route information and the position information, display control unit 57 generates display data in which a delivery route 65 of the related package and icon 63 indicating the position of delivery vehicle 7 are superimposed on map 60 indicated by map information 51. Delivery route 65 indicates a route on map 60 on which delivery vehicle 7 is scheduled to actually travel, and icon 63 indicates an actual position of delivery vehicle 7 on delivery route 65.

Thereafter, chart display processing (step S7 in FIG. 5) and remaining information display processing (step S8 in FIG. 5) are executed. Chart 70 is displayed in the chart display processing, and remaining information 80 is displayed in the remaining information display processing.

Next, processing for shipper X (shipper terminal 2X), recipient A (recipient terminal 3A), and the administrator (administrator terminal 5) of delivery vehicle 7 is described as an example. Also for these users, the processing shown in FIG. 5 is repeatedly executed at predetermined time intervals.

However, as shown in FIG. 6, for shipper X and recipient A, since base B which is the delivery destination of a non-related package b does not exist in delivery route 61 of a related package a (delivery route 61 from delivery center to base A) (NO in step S4), display control unit 57 always shifts to step S9.

For the administrator of delivery vehicle 7 or the administrator of the package delivered by delivery vehicle 7, since there is no non-related package (NO in step S4), display control unit 57 always shifts to step S9.

In step S9, display control apparatus 4 generates display data in which an icon indicating the position of delivery vehicle 7 in the delivery route of delivery vehicle 7 is superimposed on a map, and transmits the display data to the terminals used by the user (here, shipper terminal 2X, recipient terminal 3A, and administrator terminal 5), thereby causing the terminals to display the display data.

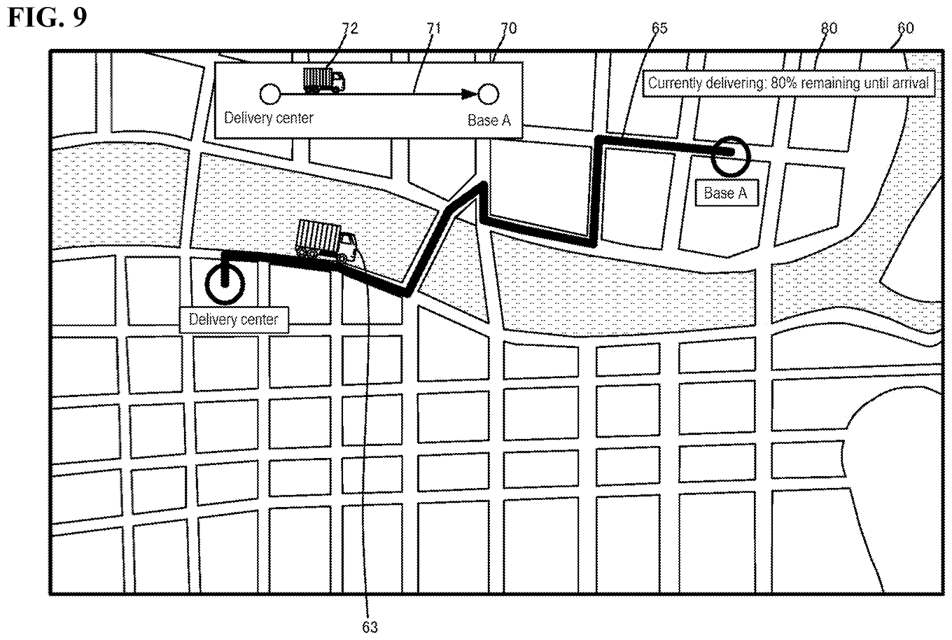

FIG. 9 is a diagram showing an example of display data generated in the display data display processing (step S9 in FIG. 5).

FIG. 9 shows display data displayed on the display screens of shipper terminal 2X and recipient terminal 3A as an example.

Based on the route information and the position information, display control unit 57 generates display data in which delivery route 65 to the delivery destination (here, base A) of the related package and icon 63 indicating the position of delivery vehicle 7 are superimposed on map 60 indicated by map information 51. Delivery route 65 indicates a route on map 60 on which delivery vehicle 7 is scheduled to actually travel, and icon 63 indicates an actual position of delivery vehicle 7 on delivery route 65. Note that the display data does not include the delivery route from base A to the delivery destination (here, base B) of the non-related package. Thus, the delivery status to base B can be hidden from shipper X and recipient A.

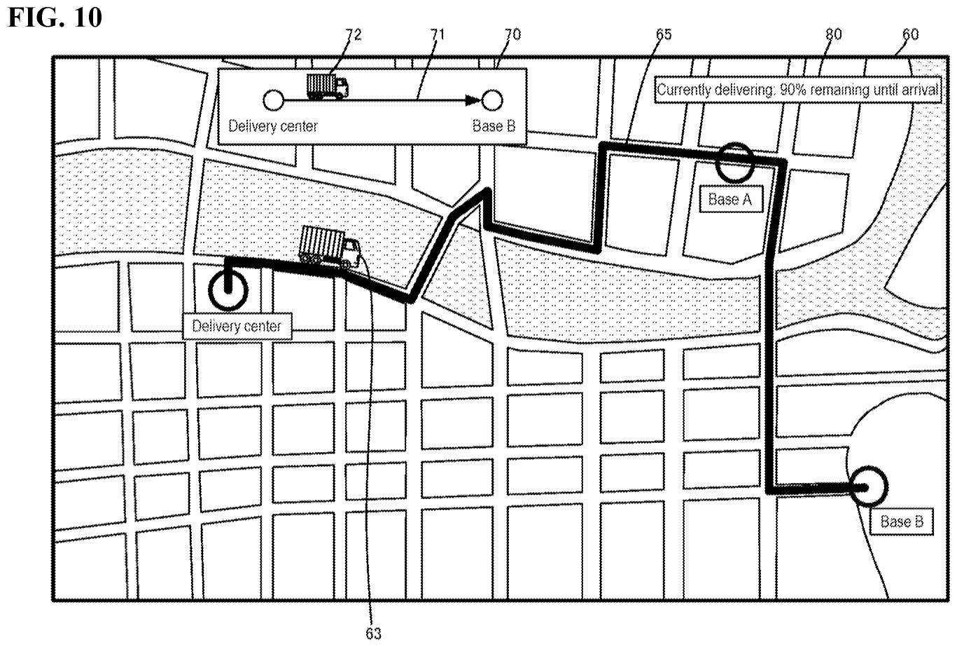

FIG. 10 is a diagram showing an example of display data generated in the display data display processing (step S9 in FIG. 5).

FIG. 10 shows display data displayed on the display screen of administrator terminal 5 as an example.

Based on the route information and the position information, display control unit 57 generates display data in which delivery route 65 to the delivery destinations (here, base A and base B) of the related package and icon 63 indicating the position of delivery vehicle 7 are superimposed on map 60 indicated by map information 51. Delivery route 65 indicates a route on map 60 on which delivery vehicle 7 is scheduled to actually travel, and icon 63 indicates an actual position of delivery vehicle 7 on delivery route 65. The display data includes the delivery route to the delivery destinations (base A and base B) of the related packages (packages a, b) for the administrator of delivery vehicle 7, and does not include the delivery route to the delivery destination of the package which is not set as the delivery target by delivery vehicle 7. As a result, the delivery route of a package other than the package delivered by delivery vehicle 7, that is, the delivery route of the package delivered by a vehicle managed by another administrator different from the administrator of delivery vehicle 7 can be prevented from being shown to the administrator of delivery vehicle 7.

### Effects of Embodiment 1

As described above, according to Embodiment 1 of the present disclosure, since the delivery destination of non-related package a is not included in abstracted route 62 shown in FIG. 7, base A which is the delivery destination of non-related package a is not displayed on map 60. Therefore, the delivery route of non-related package a is not known to the users (shipper Y and recipient B). Icon 63 is displayed at a position on abstracted route 62 corresponding to the position of delivery vehicle 7 in delivery route 61 shown in FIG. 6. Therefore, the user can grasp the rough position of delivery vehicle 7 and confirm the delivery status of related package b. For this reason, the delivery status of related package b can be naturally displayed to the user without the delivery route of non-related package a being known to other shippers or other recipients.

Note that abstracted route 62 is a straight line connecting the delivery origin and the delivery destination of related package b. Therefore, icon 63 corresponding to the position of delivery vehicle 7 can be displayed on the straight line, and the user can intuitively grasp the rough position of delivery vehicle 7, the remaining distance to the delivery destination, and the like.

When related package b approaches base B which is the delivery destination of related package b, icon 63 is displayed on the normal delivery route 65 as shown in FIG. 8. Therefore, the user can know the accurate position of delivery vehicle 7.

Further, since congested section 64 is displayed on abstracted route 62 shown in FIG. 7, the user can easily know whether or not delivery vehicle 7 is on congested section 64 by viewing icon 63.

As shown in FIG. 7, chart 70 includes corresponding line 71 of delivery route 61 of related package b and icon 72 indicating a position on corresponding line 71 corresponding to the position of delivery vehicle 7 in delivery route 61. Therefore, the user can intuitively grasp the progress degree of the delivery of related package b by delivery vehicle 7 by viewing corresponding line 71 and icon 72 on corresponding line 71.

Also, as shown in FIG. 7, remaining information 80 is displayed. Accordingly, the user can check the remaining distance or remaining time to the delivery destination.

When package a is the related package, as shown in FIG. 8, delivery route 65 of related package a and icon 63 indicating the position of delivery vehicle 7 in delivery route 65 are superimposed on map 60. Therefore, when there is no transit point of a competitor or the like on delivery route 65 of related package a, the users (shipper X and recipient A) can confirm the accurate delivery route 65 from the delivery origin to the delivery destination and the position of delivery vehicle 7.

When the user is the shipper of the package, the related package is the package delivered from the shipper. Therefore, the delivery route of a package other than the package delivered from the shipper can be prevented from being shown to the shipper of the package.

When the user is the recipient of the package, the related package is the package delivered to the recipient. Therefore, it is possible to prevent the delivery route of a package other than the package delivered to the recipient from being shown to the recipient of the package.

When the user is the administrator of delivery vehicle 7 or the administrator of the package delivered by delivery vehicle 7, the related package is the package delivered by delivery vehicle 7. Therefore, the delivery route of a package other than the package delivered by delivery vehicle 7, that is, the delivery route of the package delivered by a vehicle managed by another administrator different from the administrator of delivery vehicle 7 can be prevented from being shown to the administrator of delivery vehicle 7.

In addition, when there is a possibility that the delivery route of the non-related package is known to the user, an abstracted route that does not include the delivery destination of the non-related package is obtained. For this reason, it is possible to naturally display the delivery status of the related package to the user without the delivery route of the non-related package being known to the user who is another shipper or another recipient.

### Embodiment 2

In Embodiment 1, abstracted route 62 is indicated by the straight line as shown in FIG. 7. However, abstracted route 62 is not limited to the straight line. In Embodiment 2, an example in which an abstracted route is represented by a curved line is described.

The configuration of collective delivery system 1 is similar to that of Embodiment 1. Therefore, a detailed description thereof is not be repeated here. A method of generating display data by display control unit 57 is different from that in Embodiment 1. That is, display control unit 57 generates the display data as follows.

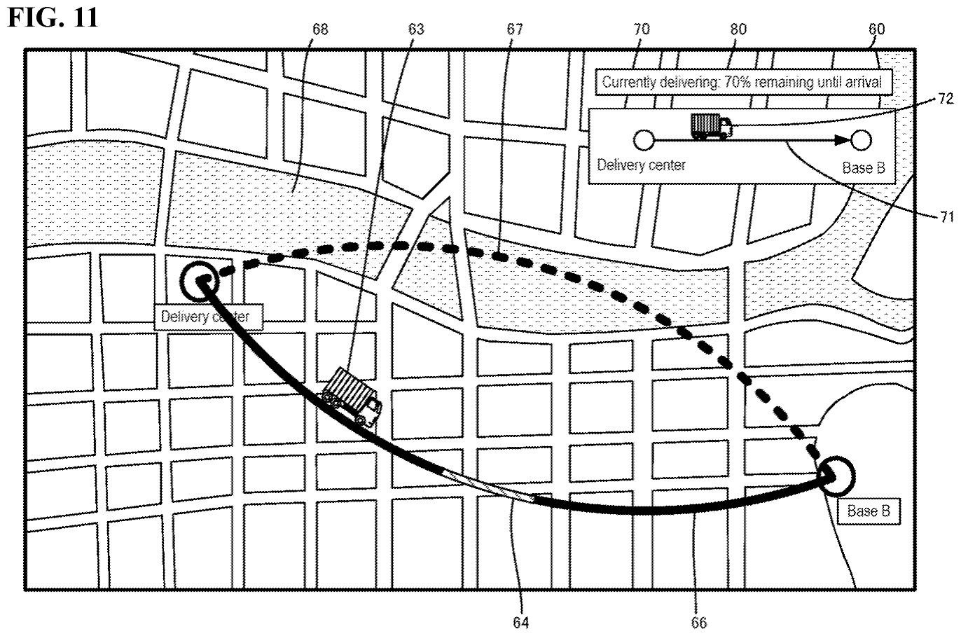

FIG. 11 is a diagram showing an example of display data displayed on the display screens of the terminal devices used by shipper Y and recipient B. Display control unit 57 generates display data in which an abstracted route 66 of a curved line is superimposed on map 60 instead of abstracted route 62 of the straight line shown in FIG. 7.

Here, display control unit 57 does not generate an abstracted route 67 passing through an area where delivery vehicle 7 cannot travel, such as a river 68, but generates abstracted route 66 passing through an area where delivery vehicle 7 can travel, such as the ground.

Display control unit 57 superimposes icon 63 indicating the position of delivery vehicle 7 on abstracted route 66. Icon 63 is arranged at a position on abstracted route 66 corresponding to the position of delivery vehicle 7 in delivery route 61 of related package b. For example, in delivery route 61 shown in FIG. 6, when the ratio of the distance from the delivery center to the position of delivery vehicle 7 to the distance from the delivery center to base B is 30%, display control unit 57 arranges icon 63 at a position of 30% from the delivery center of abstracted route 66.

Also, display control unit 57 displays congested section 64 on abstracted route 66 based on congested section information acquisition unit 56. For example, in delivery route 61 shown in FIG. 6, when congestion occurs in the section where the ratio of the distance from the delivery center to the distance from the delivery center to base B is 40% to 60%, display control unit 57 arranges congested section 64 in the section of 40% to 60% from the delivery center of abstracted route 66.

Thus, the delivery status of related package b can be presented to the user without giving a sense of incongruity to the user.

### Embodiment 3

In Embodiment 1, abstracted route 62 is represented by the straight line as shown in FIG. 7, and in Embodiment 2, abstracted route 66 is represented by the curved line as shown in FIG. 11. However, the abstracted route is not limited to a line. In Embodiment 3, an example in which the abstracted route is indicated by an area is described.

The configuration of collective delivery system 1 is similar to that of Embodiment 1. Therefore, a detailed description thereof is not repeated here. A method of generating display data by display control unit 57 is different from that in Embodiment 1. That is, display control unit 57 generates the display data as follows.

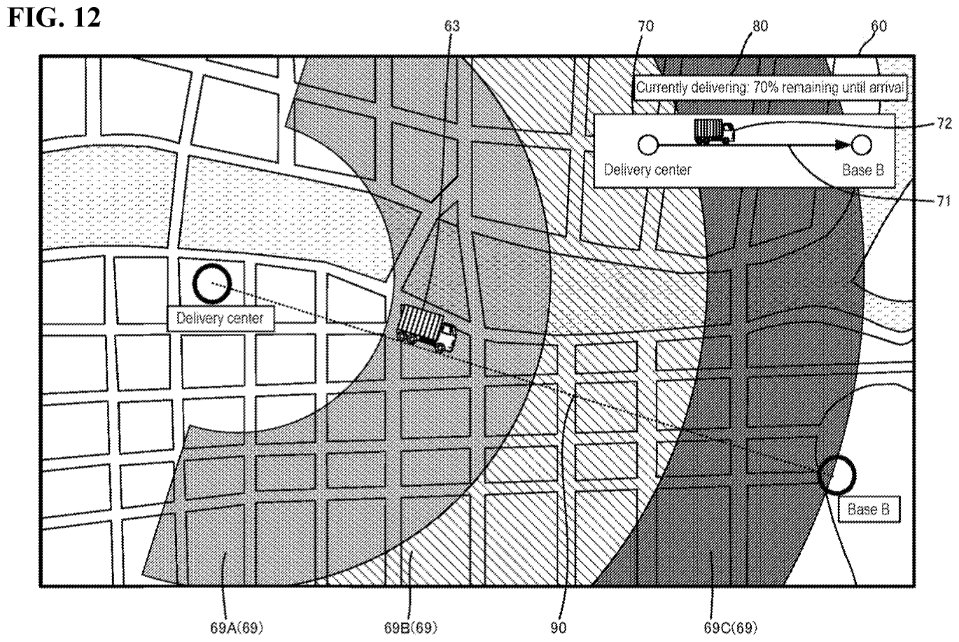

FIG. 12 is a diagram showing an example of display data displayed on the display screens of the terminal devices used by shipper Y and recipient B. Display control unit 57 generates display data in which the abstracted route composed of areas 69A to 69C is superimposed on map 60 instead of abstracted route 62 of the straight line shown in FIG. 7. In the following description, when areas 69A to 69C are not distinguished from each other, they are referred to as an area 69.

Here, each area 69 is an area based on the arrival distance from the delivery origin of related package b. For example, area 69A indicates an area whose distance from the delivery center is equal to or greater than a and less than b. Area 69B indicates an area whose distance from the delivery center is equal to or greater than b and less than c. Area 69C indicates an area whose distance from the delivery center is equal to or greater than c and less than d. Here, a<b<c<d is assumed. Each area is displayed in a different mode (for example, different color, hatching, or the like) so as to be distinguished from other adjacent areas. Note that area 69B is an area including a congested section, and is displayed in a mode (for example, red) that it can be seen that it includes the congested section. That is, it is indicated that the congestion occurs in a range where the distance from the delivery center is equal to or greater than b and less than c.

Display control unit 57 arranges icon 63 on a straight line 90 connecting the delivery center and base B which is the delivery destination of related package b on map 60. Icon 63 is arranged at a position on straight line 90 corresponding to the position of delivery vehicle 7 in delivery route 61 of related package b shown in FIG. 6. For example, in delivery route 61, when the ratio of the distance from the delivery center to the position of delivery vehicle 7 to the distance from the delivery center to base B is 30%, display control unit 57 arranges icon 63 at a position of 30% from the delivery center of straight line 90.

According to Embodiment 3, the user can intuitively grasp the arrival distance of delivery vehicle 7 from the delivery origin of related package b by recognizing areas 69A to 69C in which icon 63 is superimposed and displayed.

However, each area 69 is not limited to the area based on the arrival distance from the delivery origin (delivery center) of related package b. For example, each area 69 may be an area based on an arrival distance from the delivery destination (base B) of related package b. That is, each area 69 indicates an area whose arrival distance from base B is included in the same predetermined range. The ranges of the arrival distances of areas 69A to 69C are set so as not to overlap each other. Thus, the user can intuitively grasp the arrival distance from delivery vehicle 7 to the delivery destination of related package b.

Also, each area 69 may be an area based on the arrival time from the delivery origin (delivery center) of related package b. That is, each area 69 indicates an area in which the arrival time from the delivery center is included in the same predetermined range. The ranges of the arrival times of areas 69A to 69C are set so as not to overlap each other. For example, area 69A indicates a reachable range within 20 minutes or more and less than 40 minutes from the delivery center. Area 69B indicates a range reachable from the delivery center within 40 minutes or more and less than 60 minutes. Area 69C indicates a range reachable from the delivery center within 60 minutes or more and less than 80 minutes.

Also, each area 69 may be an area based on the arrival time from the delivery destination (base B) of related package b. That is, each area 69 indicates an area in which the arrival time from base B is included in the same predetermined range. The ranges of the arrival times of areas 69A to 69C are set so as not to overlap each other.

### SUPPLEMENTARY NOTES

Although collective delivery system 1 according to embodiments of the present disclosure has been described above, the present disclosure is not limited to these embodiments.

Each process (each function) of the above-described embodiments is achieved by a processing circuit (Circuitry) including one or more processors. The processing circuit may be configured by an integrated circuit or the like in which one or more memories, various analog circuits, and various digital circuits are combined in addition to the one or more processors. The one or more memories store programs (instructions) that cause the one or more processors to execute the processes described above. The one or more processors may execute the processes in accordance with the program read from the one or more memories, or may execute the processes in accordance with a logic circuit designed in advance to execute the processes. The processor may be any of various processors suitable for controlling a computer, such as a central processing unit (CPU), a graphics processing unit (GPU), a digital signal processor (DSP), a field programmable gate array (FPGA), and an application specific integrated circuit (ASIC). Note that the plurality of processors physically separated from each other may cooperate with each other to execute the processes. For example, the processor mounted on each of a plurality of physically separated computers may cooperate with each other via a network such as a local area network (LAN), a wide area network (WAN), or the Internet to execute the processes.

The computer program may be recorded in a non-transitory computer-readable recording medium such as a hard disk drive (HDD), a compact disc-read only memory (CD-ROM), or a semiconductor memory and distributed. In addition, the computer program may be transmitted and distributed via an electric communication channel, a wireless or cable communication channel, a network represented by the Internet, data broadcasting, or the like.

In addition, some or all of the functions of each of the apparatuses may be provided by cloud computing. That is, some or all of the functions of each apparatus may be achieved by the cloud server. Furthermore, at least a part of the above-described embodiments may be arbitrarily combined.

The embodiments disclosed herein are to be considered in all respects as illustrative and not restrictive. The scope of the present disclosure is defined not by the above meaning but by the claims, and is intended to include all modifications within the meaning and scope equivalent to the claims.

### REFERENCE SIGNS LIST

1 collective delivery system (collective delivery management system, information system used in collective delivery system),
2X, 2Y shipper terminal,
3A, 3B recipient terminal,
4 display control apparatus,
5 administrator terminal,
6 traffic information providing device,
7 delivery vehicle,
8 network,
40 communication I/F unit,
41 input/output I/F unit,
42 memory,
43 processor,
44 bus,
51 map information,
52 route information,
53 computer program,
54 route information acquisition unit,
55 position information acquisition unit,
56 congested section information acquisition unit,
57 display control unit,
60 map,
61, 65 delivery route,
62, 66, 67 abstracted route,
63, 72 icon,
64 congested section,
68 river,
69, 69A, 69B, 69C area,
70 chart,
71 corresponding line,
80 remaining information,
90 straight line

1. A display method for displaying a delivery status of a related package on a terminal device used by a user, the related package being a package related to the user, the display method comprising:
acquiring route information of a delivery route of target packages to be delivered by a vehicle;
acquiring position information of the vehicle; and
displaying, on the terminal device, a map with an abstracted route and an icon superimposed thereon, based on the route information and the position information, the abstracted route being a route from a delivery origin of the related package to a delivery destination of the related package and being a route excluding a delivery destination of a non-related package that is a package not related to the user among the target packages, the icon indicating a position of the vehicle on the abstracted route, the position of the vehicle on the abstracted route corresponding to a position of the vehicle on a delivery route of the related package.

2. The display method according to claim 1, wherein the abstracted route is a straight line or a curved line connecting the delivery origin of the related package and the delivery destination of the related package.

3. The display method according to claim 1, wherein the abstracted route is an area based on an arrival distance or an arrival time from the delivery origin of the related package or the delivery destination of the related package.

4. The display method according to claim 1, wherein the displaying further superimposes an icon on the map in vicinity of the delivery destination of the related package, the icon indicating the position of the vehicle on the delivery route of the related package.

5. The display method according to claim 1, further comprising:
acquiring congested section information of a congested section on the delivery route, wherein
the displaying further displays the congested section, based on the congested section information, in such a manner as to superimpose the congested section on the abstracted route.

6. The display method according to claim 1, wherein the displaying further displays a corresponding line and an icon on the terminal device, the corresponding line corresponding to the delivery route of the related package, the icon indicating a position of the vehicle on the corresponding line, the position of the vehicle on the corresponding line corresponding to the position of the vehicle on the delivery route.

7. The display method according to claim 1, wherein the displaying further displays remaining information on the terminal device, the remaining information being related to a remaining distance or a remaining time to the delivery destination of the related package.

8. The display method according to claim 1, wherein the displaying superimposes, on the map, the delivery route of the related package and an icon indicating the position of the vehicle on the delivery route when the delivery destination of the non-related package is not on the delivery route.

9. The display method according to claim 1, wherein the user is a shipper of a package, and
wherein the related package is a package delivered from the shipper.

10. The display method according to claim 1, wherein the user is a recipient of a package, and
wherein the related package is a package to be delivered to the recipient.

11. The display method according to claim 1, wherein the user is an administrator for the vehicle, and
wherein the related package is a package to be delivered by the vehicle.

12. The display method according to claim 1, further comprising:
determining the abstracted route when the non-related package is on the delivery route and the position of the vehicle is not in vicinity of the delivery destination of the related package.

13. (canceled)

14. (canceled)

15. The display method according to claim 2, wherein the displaying further superimposes an icon on the map in vicinity of the delivery destination of the related package, the icon indicating the position of the vehicle on the delivery route of the related package.

16. The display method according to claim 2, further comprising:
acquiring congested section information of a congested section on the delivery route, wherein
the displaying further displays the congested section, based on the congested section information, in such a manner as to superimpose the congested section on the abstracted route.

17. The display method according to claim 2, wherein the displaying further displays remaining information on the terminal device, the remaining information being related to a remaining distance or a remaining time to the delivery destination of the related package.

18. The display method according to claim 3, wherein the displaying further superimposes an icon on the map in vicinity of the delivery destination of the related package, the icon indicating the position of the vehicle on the delivery route of the related package.

19. The display method according to claim 3, further comprising:
acquiring congested section information of a congested section on the delivery route, wherein
the displaying further displays the congested section, based on the congested section information, in such a manner as to superimpose the congested section on the abstracted route.

20. The display method according to claim 3, wherein the displaying further displays remaining information on the terminal device, the remaining information being related to a remaining distance or a remaining time to the delivery destination of the related package.

21. A display control apparatus for causing a terminal device used by a user to display a delivery status of a related package, the related package being a package related to the user, the display control apparatus comprising:
a route information acquisition unit configured to acquire route information of a delivery route of target packages to be delivered by a vehicle;
a position information acquisition unit configured to acquire position information of the vehicle; and
a display control unit configured to cause the terminal device to display a map with an abstracted route and an icon superimposed thereon, based on the route information and the position information, the abstracted route being a route from a delivery origin of the related package to a delivery destination of the related package and being a route excluding a delivery destination of a non-related package not related to the user among the target packages, the icon indicating a position of the vehicle on the abstracted route, the position of the vehicle on the abstracted route corresponding to a position of the vehicle on a delivery route of the related package.

22. A non-transitory computer-readable storage medium storing a computer program for causing a computer to function as a display control apparatus for causing a terminal device used by a user to display a delivery status of a related package, the related package being a package related to the user, the computer program causing the computer to function as:
a route information acquisition unit configured to acquire route information of a delivery route of target packages to be delivered by a vehicle;
a position information acquisition unit configured to acquire position information of the vehicle; and
a display control unit configured to cause the terminal device to display a map with an abstracted route and an icon superimposed thereon, based on the route information and the position information, the abstracted route being a route from a delivery origin of the related package to a delivery destination of the related package and being a route excluding a delivery destination of a non-related package that is a package not related to the user among the target packages, the icon indicating a position of the vehicle on the abstracted route, the position of the vehicle on the abstracted route corresponding to a position of the vehicle on a delivery route of the related package.
